(19) United States
(12) Patent Application Publication
(10) Pub. No.: US 2016/0357053 A1
(43) Pub. Date: Dec. 8, 2016

(54) Liquid Crystal Display Device

(71) Applicant: SHENZHEN CHINA STAR OPTOELECTRONICS TECHNOLOGY CO., LTD., Shenzhen, Guangdong (CN)

(72) Inventors: Shihhsiang CHEN, Shenzhen, Guangdong (CN); Chengwen QUE, Shenzhen, Guangdong (CN)

(73) Assignee: Shenzhen China Star Optoelectronics Technology Co., Ltd., Shenzhen, Guangdong (CN)

(21) Appl. No.: 14/442,508

(22) PCT Filed: Mar. 3, 2015
(86) PCT No.: PCT/CN2015/073586

§ 371 Date: May 13, 2015

(30) Foreign Application Priority Data
Feb. 4, 2015 (CN) 201510059958.2

(51) Int. Cl. G02F 1/1333; F21V 8/00; G02F 1/1335

(52) U.S. Cl. CPC G02F 1/133308; G02F 1/133512; G02B 6/0055; G02B 6/005; G02F 2202/28; G02F 2001/133317

(57) ABSTRACT

A liquid display device comprises a backlight unit, a display panel and a first bezel containing the backlight unit and the display panel. At least one sidewall of the first bezel is formed with an extension portion in an arc shape extending toward a middle portion of the first bezel. A free end of the extension portion is disposed opposite to a sidewall of the display panel. The display panel is disposed in the first bezel. The extension portion helps to form the smooth transition between the display panel and the first bezel. The cover glass disposed on the liquid display device is not required. The complex cover glass polishing process is eliminated. The limitation of the 2.5D display screen only applied in the application of the small-size display screen is also eliminated. The disclosure reduces the production cost and increases the application range of the display screen.

### BACKGROUND

1. Field of the Invention

The disclosure is related to a display device manufacturing field, and more particular to a liquid crystal display device.

2. The Related Arts

After the 2.5D (Dimension) display screen is announced to use in IPhone 6, this concept of the display screen becomes one of the hot topical subjects between the consumers. The 2.5D display screen is distinguished from the 3D display screen. Compared to the traditional 2D display screen, the 2.5D display screen greatly enhances the visual effect of the screen and whole body. At the same time, feel can be improved because of no blunt edges.

The current 2.5D display screen can only be applied on a small-size display. The exterior of the display comprises a flat region and a cambered surface at the edge of the display. The implementation of the current 2.5D display screen is provided with a cover glass in front of the LCD screen (or the touch screen). In order to satisfy the features of the 2.5D display screen, the edge of the cover glass is worked out to form a circle of transit cambered surface through polishing process. Because the process is complex and there are restrictions on the size, the product cost is increased and design of the product diversification is limited.

The manufacturing technology of the current 2.5D display screen is much complex. Some overly unsmooth situation occurs for the case of glass polishing process during the manufacturing process. There is some loss of the yield. Therefore, the cost of the 2.5D display screen is higher than the traditional 2D display screen. This technology cannot be applied in the mass production of the large-size display screen currently. The 2.5D display screen is only applied in the application of the small-size display screen and the application of the product diversification is also limited.

### SUMMARY

In view of the deficiencies of the prior art, the disclosure provides a display device having low product cost and satisfying the diversification design on the screen.

In order to accomplish the above purpose, the disclosure provides the following technical solutions.

In one embodiment, the disclosure provides a liquid crystal display device. The liquid crystal display device comprises a backlight unit, a display panel and a first bezel. The first bezel contains the backlight unit and the display panel. At least one sidewall of the first bezel is formed with an extension portion in an arc shape extending toward a middle portion of the first bezel; a free end of the extension portion is disposed opposite to a sidewall of the display panel.

In one embodiment, the upper surface of the display panel is aligned with the upper surface of the extension portion.

In one embodiment, the lower surface of the display panel is adhesive to the backlight unit.

In one embodiment, a varnish layer is formed on the upper surface of the extension portion.

In one embodiment, the OLB area of the display panel is disposed opposite to the first bezel; a flexible light-blocking adhesive is filled between the OLB area and the lower surface of the extension portion; the flexible light-blocking adhesive is filled between the end face of the free end of the extension portion and the display panel.

In one embodiment, the backlight unit comprises optical films, a light guide plate, a reflective sheet, a backplane and a second bezel; the second bezel comprises a top plate having a top surface and a side plate having a side surface; the display panel is adhesive on the upper surface of the top plate.

In one embodiment, a first groove and a second groove are disposed on the top plate and the side plate respectively; the backplane comprises a vertical plate having a plurality of protruded elastic hooks; the upper end of the vertical plate is inserted into the first groove and the elastic hook is embedded in the second groove.

In one embodiment, the backplane comprises a horizontal plate integrated with the vertical plate; the optical films, the light guide plate and the reflective sheet are sequentially stacked on the horizontal plate; the horizontal plate is closely attached to the bottom plane of the first bezel.

The display panel of the disclosure is disposed in the first bezel. At least one sidewall of the first bezel is formed with an extension portion in an arc shape extending toward a middle portion of the first bezel. The smooth transition between the display panel and the first bezel is formed by the extension portion. The cover glass disposed on the liquid display device of the disclosure is not required. The complex cover glass polishing process is eliminated. The limitation of the 2.5D display screen only applied in the application of the small-size display screen is also eliminated. The disclosure reduces the production cost and increases the application range of the display screen.

### BRIEF DESCRIPTION OF THE DRAWINGS

The above and other exemplary aspects, features and advantages of certain exemplary embodiments of the present disclosure will be more apparent from the following description taken in conjunction with the accompanying drawings, in which:

FIG. 1 is the schematic diagram of a liquid crystal display device according to the disclosure; and

FIG. 2 is the top view of a liquid crystal display device according to the disclosure.

### DETAILED DESCRIPTION

The following description with reference to the accompanying drawings is provided to clearly and completely explain the exemplary embodiments of the disclosure. It is apparent that the following embodiments merely intend to explain but not to limit the present disclosure.

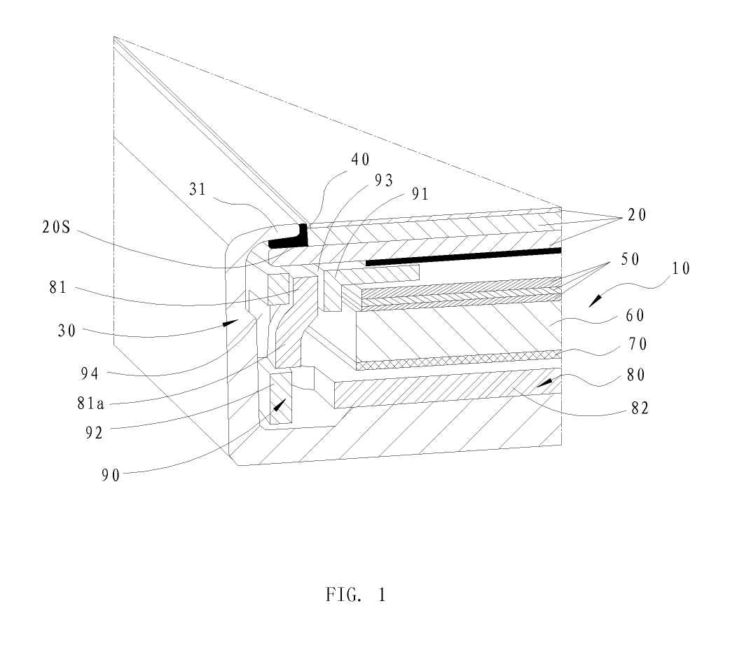

Refer to FIG. 1. The liquid crystal display device comprises a backlight unit 10, a display panel 20 and a first bezel 30. The first bezel 30 is an embellishing border and specifically a frame integrally formed with the sides of the display device. The first bezel 30 contains the backlight unit 10 and the display panel 20. At least one sidewall of the first bezel 30 is formed with an extension portion 31 in an arc shape extending toward the middle portion of the first bezel 30. A free end of the extension portion 31 is disposed opposite to the sidewall of the display panel 20. The extension portion 31 in an arc shape can be made by conventional mechanical processing or mold forming. The processing is low cost and easy to accomplish.

The embodiment of the disclosure does not need to manufacture the cover glass with cambered surface by polishing process required in the 2.5D display screen. The display panel disposed with the first bezel 30 formed with the extension portion 31 in an arc shape can accomplish the display effect of the 2.5D display screen. The disclosure reduces the component cost and complex manufacturing process. The disclosure may also facilitate the thin design on the products.

The upper surface of the display panel 20 is aligned with the upper surface of the extension portion 31. Therefore, the transitional region between the display panel 20 and the embellishing border is smoother. A varnish layer is formed on the upper surface of the extension portion, for example the UV varnish. The varnish layer is formed the upper surface of the extension portion by the spraying, printing or coating processes. Thus the extension portion may have the luster approximate to the material of the display screen having the varnish layer and makes the feature of the 2.5D display screen more vivid.

Specifically, the lower surface of the display panel 20 is adhesive to the backlight unit 10. An outer lead bonding (OLB) area 20S of the display panel 20 is disposed opposite to the first bezel 30. The display panel and the chip on film (COF) are conjugated by the anisotropic conductive film (ACF) in the manufacturing process of the display panel 20. The anisotropic conductive film (ACF) has stickiness and inner conductive balls that the conductive balls are isolated from each other. A flexible light-blocking adhesive 40 is filled between the OLB area 20S and the lower surface of the extension portion 31. The flexible light-blocking adhesive 40 is filled between the end face of the free end of the extension portion 31 and the display panel 20.

The backlight unit 10 comprises optical films 50, a light guide plate 60, a reflective sheet 70, a backplane 80 and a second bezel 90. The second bezel 90 comprises a top plate 91 having a top surface and a side plate 92 having a side surface. The display panel 20 is adhesive on the upper surface of the top plate 91.

The backplane 80 is installed on the second bezel 90 that is the frame of the display device by engagement of the elastic hook 81a. Specifically, a first groove 93 and a second groove 94 are disposed on the top plate 91 and the side plate 92 respectively. The backplane 80 comprises a vertical plate 81 having a plurality of protruded elastic hooks 81a. The upper end of the vertical plate 81 is inserted into the first groove 93 and the elastic hook 81a is embedded in the second groove 94. The backplane 80 comprises a horizontal plate 81 integrated with the vertical plate 82. The optical films 50, the light guide plate 60 and the reflective sheet 70 are sequentially stacked on the horizontal plate 82. The horizontal plate 82 is closely attached to the bottom plane of the first bezel 30.

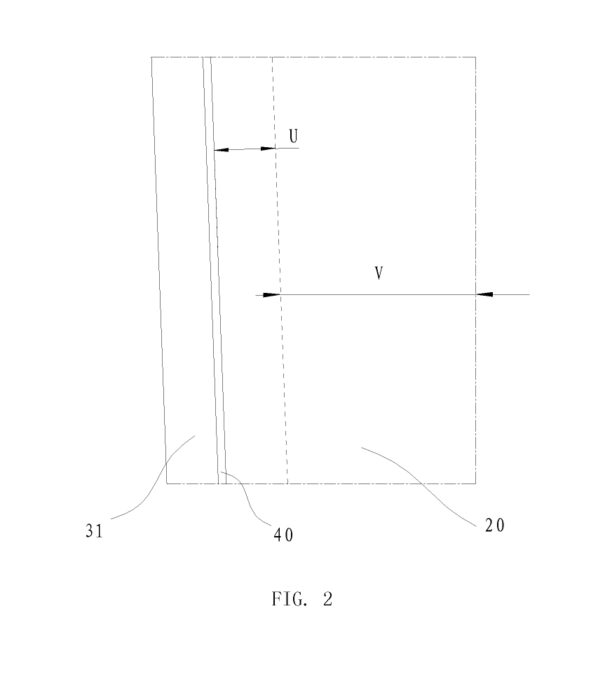

Also refer to FIG. 2. The display panel 20 comprises the display area V and non-display area U next to the display area V. When fabricating the display device, the flexible light-blocking adhesive 40 is disposed in a circle at the OLB area 20S before assembling the embellishing border. After that, the extension portion 31 is assembled and the flexible light-blocking adhesive 40 is compressed by the extension portion 31. The flexible light-blocking adhesive 40 flows along the shape of the free end of the extension portion 31 and the assembly direction and fills the gap between the extension portion 31 and the display panel 20. The gap is filled after the flexible light-blocking adhesive 40 is cured. The smooth transition region of the display panel 20 is achieved and the 2.5D display effect is achieved.

The display panel of the disclosure is disposed in the first bezel 30. At least one sidewall of the first bezel 30 is formed with an extension portion 31 in an arc shape extending toward a middle portion of the first bezel 30. The transition between the display panel and the first bezel is smoothly. The flexible light-blocking adhesive 40 is filled between the OLB area 20S and the lower surface of the extension portion 31. The flexible light-blocking adhesive 40 is filled between the end face of the free end of the extension portion 31 and the display panel 20. The cover glass disposed on the liquid display device of the disclosure is cancelled. The complex cover glass polishing process is eliminated. The limitation of the 2.5D display screen only applied in the application of the small-size display screen is also eliminated. The disclosure reduces the production cost and increases the application scope of the display screen.

Although the present disclosure is illustrated and described with reference to specific embodiments, those skilled in the art will understand that many variations and modifications are readily attainable without departing from the spirit and scope. Such variations and modifications should also be regarded as the protection of the disclosure.

What is claimed is:

1. A liquid crystal display device, comprising:
a backlight unit;
a display panel; and
a first bezel containing the backlight unit and the display panel;
wherein at least one sidewall of the first bezel is formed with an extension portion in an arc shape extending toward a middle portion of the first bezel; a free end of the extension portion is disposed opposite to a sidewall of the display panel.

2. The liquid crystal display device according to claim 1, wherein the upper surface of the display panel is aligned with the upper surface of the extension portion.

3. The liquid crystal display device according to claim 1, wherein the lower surface of the display panel is adhesive to the backlight unit.

4. The liquid crystal display device according to claim 1, wherein a varnish layer is formed on the upper surface of the extension portion.

5. The liquid crystal display device according to claim 1, wherein the OLB area of the display panel is disposed opposite to the first bezel; a flexible light-blocking adhesive is filled between the OLB area and the lower surface of the extension portion; the flexible light-blocking adhesive is filled between the end face of the free end of the extension portion and the display panel.

6. The liquid crystal display device according to claim 5, wherein the backlight unit comprises optical films, a light guide plate, a reflective sheet, a backplane and a second bezel; the second bezel comprises a top plate having a top surface and a side plate having a side surface; the display panel is adhesive on the upper surface of the top plate.

7. The liquid crystal display device according to claim 6, wherein a first groove and a second groove are disposed on the top plate and the side plate respectively; the backplane comprises a vertical plate having a plurality of protruded elastic hooks; the upper end of the vertical plate is inserted into the first groove and the elastic hook is embedded in the second groove.

8. The liquid crystal display device according to claim 6, wherein the backplane comprises a horizontal plate integrated with the vertical plate; the optical films, the light guide plate and the reflective sheet are sequentially stacked on the horizontal plate; the horizontal plate is closely attached to the bottom plane of the first bezel.

9. The liquid crystal display device according to claim 2, wherein the OLB area of the display panel is disposed opposite to the first bezel; a flexible light-blocking adhesive is filled between the OLB area and the lower surface of the extension portion; the flexible light-blocking adhesive is filled between the end face of the free end of the extension portion and the display panel.

10. The liquid crystal display device according to claim 9, wherein the backlight unit comprises optical films, a light guide plate, a reflective sheet, a backplane and a second bezel; the second bezel comprises a top plate having a top surface and a side plate having a side surface; the display panel is adhesive on the upper surface of the top plate.

11. The liquid crystal display device according to claim 10, wherein a first groove and a second groove are disposed on the top plate and the side plate respectively; the backplane comprises a vertical plate having a plurality of protruded elastic hooks; the upper end of the vertical plate is inserted into the first groove and the elastic hook is embedded in the second groove.

12. The liquid crystal display device according to claim 10, wherein the backplane comprises a horizontal plate integrated with the vertical plate; the optical films, the light guide plate and the reflective sheet are sequentially stacked on the horizontal plate; the horizontal plate is closely attached to the bottom plane of the first bezel.

13. The liquid crystal display device according to claim 3, wherein the OLB area of the display panel is disposed opposite to the first bezel; a flexible light-blocking adhesive is filled between the OLB area and the lower surface of the extension portion; the flexible light-blocking adhesive is filled between the end face of the free end of the extension portion and the display panel.

14. The liquid crystal display device according to claim 13, wherein the backlight unit comprises optical films, a light guide plate, a reflective sheet, a backplane and a second bezel; the second bezel comprises a top plate having a top surface and a side plate having a side surface; the display panel is adhesive on the upper surface of the top plate.

15. The liquid crystal display device according to claim 14, wherein a first groove and a second groove are disposed on the top plate and the side plate respectively; the backplane comprises a vertical plate having a plurality of protruded elastic hooks; the upper end of the vertical plate is inserted into the first groove and the elastic hook is embedded in the second groove.

16. The liquid crystal display device according to claim 14, wherein the backplane comprises a horizontal plate integrated with the vertical plate; the optical films, the light guide plate and the reflective sheet are sequentially stacked on the horizontal plate; the horizontal plate is closely attached to the bottom plane of the first bezel.

17. The liquid crystal display device according to claim 4, wherein the OLB area of the display panel is disposed opposite to the first bezel; a flexible light-blocking adhesive is filled between the OLB area and the lower surface of the extension portion; the flexible light-blocking adhesive is filled between the end face of the free end of the extension portion and the display panel.

18. The liquid crystal display device according to claim 17, wherein the backlight unit comprises optical films, a light guide plate, a reflective sheet, a backplane and a second bezel; the second bezel comprises a top plate having a top surface and a side plate having a side surface; the display panel is adhesive on the upper surface of the top plate.

19. The liquid crystal display device according to claim 18, wherein a first groove and a second groove are disposed on the top plate and the side plate respectively; the backplane comprises a vertical plate having a plurality of protruded elastic hooks; the upper end of the vertical plate is inserted into the first groove and the elastic hook is embedded in the second groove.

20. The liquid crystal display device according to claim 18, wherein the backplane comprises a horizontal plate integrated with the vertical plate; the optical films, the light guide plate and the reflective sheet are sequentially stacked on the horizontal plate; the horizontal plate is closely attached to the bottom plane of the first bezel.
